(19) United States
(12) Patent Application Publication
(10) Pub. No.: US 2008/0284067 A1
(43) Pub. Date: Nov. 20, 2008

(54) METHOD FOR MANUFACTURING MATERIAL FOR SILICON CARBIDE FIRED BODY AND METHOD FOR MANUFACTURING HONEYCOMB STRUCTURE

(75) Inventors: Kazuya NARUSE, Courtenay (FR); Kosei Tajima, Ibi-gun (JP)

Correspondence Address: DITTHAVONG MORI & STEINER, P.C., 918 Prince St., Alexandria, VA, 22314, US

(73) Assignee: IBIDEN CO., LTD., Ogaki-shi (JP)

(21) Appl. No.: 12/117,262

(22) Filed: May 8, 2008

(30) Foreign Application Priority Data
May 9, 2007 (JP) PCT/JP2007/059616

(51) Int. Cl. B28C 7/04

(52) U.S. Cl. 264/630; 366/18

(57) ABSTRACT

A material for a silicon carbide fired body is manufactured by wet mixing at least a silicon carbide powder and an iron compound powder. A honeycomb structure is manufactured by molding a raw material composition containing the material for a silicon carbide fired body and an additive to manufacture a honeycomb molded body which has cell walls extending along a longitudinal direction of the honeycomb molded body to define a plurality of cells extending along the longitudinal direction. The honeycomb molded body is degreased to manufacture a honeycomb degreased body. The honeycomb degreased body is fired to manufacture a honeycomb structure including a honeycomb fired body.

### CROSS-REFERENCE TO RELATED APPLICATIONS

The present application claims priority under 35 U.S.C. §119 to PCT Application No. PCT/JP2007/059616, filed May 9, 2007, the contents of which are incorporated herein by reference in their entirety.

### BACKGROUND OF THE INVENTION

1. Field of the Invention

The present invention relates to a method for manufacturing a material for a silicon carbide fired body, and a method for manufacturing a honeycomb structure.

2. Discussion of the Background

There has recently been a problem that particulates such as soot contained in exhaust gases discharged from internal combustion engines of vehicles such as buses and trucks, and construction machines and the like cause harm to the environment and the human body.

For this reason, there have been proposed various kinds of honeycomb filters using a honeycomb structure including porous ceramics as a filter for capturing particulates contained in exhaust gasses and purifying the exhaust gases.

As a honeycomb structure of this kind, there has been proposed a honeycomb structure including silicon carbide, due to the excellent high-temperature resistance.

There has been known a method, for example, disclosed in JP01-258715A, as a method for manufacturing a honeycomb fired body including silicon carbide as described above.

Specifically, there is disclosed a method for carrying out a first process of manufacturing a honeycomb molded body by carrying out molding by using a silicon carbide powder having a total content of Al, B, and Fe elements of 1% by weight or less and a free carbon content of 5% by weight or less as a starting material, a second process of sealing an end portion of a predetermined through hole of the above-mentioned honeycomb molded body with a predetermined plug material, and a third process of sintering the above-mentioned sealed honeycomb molded body in a non-oxidizing atmosphere.

The contents of JP01-258715A are incorporated herein by reference in their entirety.

### SUMMARY OF THE INVENTION

In accordance with one aspect of the present invention, a material for a silicon carbide fired body is manufactured by wet mixing at least a silicon carbide powder and an iron compound powder.

In accordance with another aspect of the present invention, a honeycomb structure is manufactured. At least a silicon carbide powder and an iron compound powder are wet mixed to manufacture a material for a silicon carbide fired body. A raw material composition containing the material for a silicon carbide fired body and an additive are molded to manufacture a honeycomb molded body which has cell walls extending along a longitudinal direction of the honeycomb molded body to define a plurality of cells extending along the longitudinal direction. The honeycomb molded body is degreased to manufacture a honeycomb degreased body. The honeycomb degreased body is fired to manufacture a honeycomb structure including a honeycomb fired body.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view schematically showing one example of a honeycomb structure manufactured by the method for manufacturing a honeycomb structure of an embodiment of the present invention;

FIG. 2A is a perspective view schematically showing a honeycomb fired body forming the honeycomb structure shown in FIG. 1; and

FIG. 2B is an A-A line cross sectional view of the honeycomb fired body shown in FIG. 2A.

### DESCRIPTION OF THE EMBODIMENTS

The embodiments will now be described with reference to the accompanying drawings, wherein like reference numerals designate corresponding or identical elements throughout the various drawings.

In the method for manufacturing a honeycomb structure, first, a honeycomb molded body is manufactured by extrusion molding, and then degreasing treatment is carried out on the honeycomb molded body.

In the degreasing treatment, a binder, a dispersant solution and the like are decomposed and removed. However, in the case where the degreasing treatment is allowed to proceed to completion with complete decomposition and removal of organic components in the honeycomb molded body in the degreasing treatment, the degreased honeycomb molded body (honeycomb degreased body) tends to have a reduced strength, and this tends to result in failure to maintain its structure, and pinholes, cracks or the like possibly occur in a honeycomb fired body obtained by carrying out firing treatment on the honeycomb degreased body.

For this reason, the honeycomb degreased body presumably needs to contain a carbon residue derived from the binder and the like.

On the other hand, upon manufacturing a honeycomb fired body by carrying out firing treatment on the honeycomb degreased body, in case of using a honeycomb degreased body containing a carbon residue, presence of the carbon among silicon carbide powders tends to interfere with contact between the silicon carbide powders, and this presumably results in prevention of sintering of the silicon carbide.

Intensive studies have been conducted to obtain an idea of mixing an iron compound powder into a raw material composition in advance, in order to remove a carbon residue contained in a honeycomb degreased body in firing treatment.

Moreover, further studies have been conducted to provide a method for manufacturing a material for a silicon carbide fired body with the following findings. It was found that an addition of the iron compound powder alone tends to fail to solve the above-mentioned problems, and that high distribution of the iron compound powders in the raw material composition tends to be needed to solve the above-mentioned problems. For this reason, the raw material composition needs to be prepared by wet mixing, or wet-pulverizing and wet-mixing a silicon carbide powder and the iron compound powder.

In addition, it was found that a method for manufacturing a honeycomb structure using a material for a silicon carbide fired body of this kind enables suitable manufacturing of a honeycomb fired body including silicon carbide.

The method for manufacturing a material for a silicon carbide fired body of an embodiment of the present invention includes wet mixing, or wet-pulverizing and wet-mixing at least a silicon carbide powder and an iron compound powder.

According to the method for manufacturing a material for a silicon carbide fired body of the embodiment of the present invention, a material for a silicon carbide fired body containing uniformly distributed iron compound powders tends to be manufactured, since the manufacturing method includes wet mixing, or wet-pulverizing and wet-mixing the silicon carbide powder and the iron compound powder.

According to the method for manufacturing a material for a silicon carbide fired body of an embodiment of the present invention, the iron compound powder includes at least one kind selected from a group consisting of Fe₂O₃, Fe₃O₄ and FeO, in the above-mentioned method for manufacturing a material for a silicon carbide fired body.

In the method for manufacturing a material for a silicon carbide fired body of the embodiment of the present invention, upon manufacturing a porous silicon carbide sintered body using the manufactured material for a silicon carbide fired body, sintering tends to be allowed to certainly proceed, since the iron compound powder includes at least one kind selected from a group consisting of Fe₂O₃, Fe₃O₄, and FeO.

The reason will be described later.

According to the method for manufacturing a material for a silicon carbide fired body of an embodiment of the present invention, the content of the iron compound powder in the material for a silicon carbide fired body is at least about 0.25% by weight and at most about 2.5% by weight, in the above-mentioned method for manufacturing a material for a silicon carbide fired body.

In the method for manufacturing a material for a silicon carbide fired body of the embodiment of the present invention, upon manufacturing a porous silicon carbide sintered body using the manufactured material for a silicon carbide fired body, sintering tends to be allowed to certainly proceed, since the content of the above-mentioned iron compound powder is at least about 0.25% by weight and at most about 2.5% by weight.

In the method for manufacturing a material for a silicon carbide fired body of an embodiment of the present invention, in a mixture obtained by wet mixing, or wet-pulverizing and wet-mixing the silicon carbide powder and the iron compound powder, an average diameter (D50) of the iron compound powder having been wet mixed, or wet-pulverized and wet-mixed (hereinafter, also simply referred to having been mixed) is at least about 0.1 μm and at most about 1.0 μm, and also equal to or less than an average particle diameter (D50) of the silicon carbide powder having been wet mixed, or wet-pulverized and wet-mixed.

This is because the iron compound powders and the silicon carbide powders tend to be uniformly mixed, by carrying out wet mixing, or wet-pulverizing and wet-mixing to obtain the iron compound powder having been mixed and the silicon carbide powder having been mixed both of which have average particle diameters within the above-mentioned ranges as the method for manufacturing a material for a silicon carbide fired body of the embodiment of the present invention.

The method for manufacturing a material for a silicon carbide fired body of an embodiment of the present invention further includes adding and mixing a silicon carbide coarse powder having a larger average particle diameter (D50) than that of the silicon carbide powder having been wet mixed, or wet-pulverized and wet-mixed, to the mixture obtained by wet mixing, or wet-pulverizing and wet-mixing the silicon carbide powder and the iron compound powder.

According to the method for manufacturing a material for a silicon carbide fired body of the embodiment of the present invention, the manufactured material for a silicon carbide fired body contains two kinds of silicon carbide particles each having a different average particle diameter, since the silicon carbide coarse powder having a larger average particle diameter (D50) is additionally added and mixed. Upon manufacturing a porous silicon carbide sintered body, a material for a silicon carbide fired body of this kind tends to allow sintering to proceed certainly and tends to enable a manufactured porous silicon carbide sintered body to have smaller variations in a pore diameter and a porosity.

According to the method for manufacturing a material for a silicon carbide fired body of an embodiment of the present invention, the silicon carbide powder having been wet mixed, or wet-pulverized and wet-mixed has an average particle diameter (D50) of at least about 0.1 μm and at most about 1.0 μm, in the method for manufacturing a material for a silicon carbide fired body of the above-mentioned embodiment.

In the method for manufacturing a material for a silicon carbide fired body of an embodiment of the present invention, in addition to the methods for manufacturing a material for a silicon carbide fired body of the above-mentioned embodiments, the silicon carbide coarse powder has an average particle diameter (D50) of at least about 0.3 μm and at most about 50 μm.

The material for a silicon carbide fired body manufactured by the methods for manufacturing a material for a silicon carbide fired body of the embodiments of the present invention is particularly suitably used for manufacturing a porous silicon carbide sintered body having a pore diameter and a porosity which are suitable for use as a honeycomb filter or a catalyst carrier.

According to the method for manufacturing a material for a silicon carbide fired body of an embodiment of the present invention, the content of the iron compound powder in the mixture obtained by wet mixing, or wet-pulverizing and wet-mixing the silicon carbide powder and the iron compound powder is at least about 1% by weight and at most about 10% by weight, in the methods for manufacturing a material for a silicon carbide fired body of the above-mentioned embodiments.

In the method for manufacturing a material for a silicon carbide fired body of the embodiment of the present invention, upon manufacturing a porous silicon carbide sintered body using the manufactured material for a silicon carbide fired body, sintering tends to be allowed to proceed more certainly, since the content of the above-mentioned iron compound is within the above-mentioned range.

According to the method for manufacturing a material for a silicon carbide fired body of an embodiment of the present invention, a silicon carbide coarse powder is added to and mixed to the mixture obtained by wet mixing, or wet-pulverizing and wet-mixing, after carrying out drying treatment on the mixture, in addition to the methods for manufacturing a material for a silicon carbide fired body of the above-mentioned embodiments.

In the method for manufacturing a material for a silicon carbide fired body of the embodiment of the present invention, since drying treatment is once carried out on the mixture obtained by wet mixing, or wet-pulverizing and wet-mixing, the silicon carbide powder and/or the iron compound powder have less tendency to agglomerate, resulting in a less amount of powders having a larger size. Therefore, upon manufacturing a porous silicon carbide sintered body using the manufactured material for a silicon carbide fired body, sintering tends to be allowed to proceed more certainly. In addition, the manufactured porous silicon carbide sintered body tends to show smaller variations in a pore diameter and a porosity.

According to the method for manufacturing a material for a silicon carbide fired body of an embodiment of the present invention, a purity of the iron compound powder is more than 80% and equal to or less than about 99%, in the above-mentioned method for manufacturing a material for a silicon carbide fired body.

In the method for manufacturing a material for a silicon carbide fired body of the embodiment of the present invention, upon manufacturing a porous silicon carbide sintered body using the manufactured material for a silicon carbide fired body, sintering tends to be allowed to proceed more certainly, since the purity of iron compound powder is within the above-mentioned range.

The method for manufacturing a honeycomb structure of an embodiment of the present invention includes: manufacturing a pillar-shaped honeycomb molded body where a large number of cells are disposed in parallel with one another in a longitudinal direction with a cell wall therebetween by molding a raw material composition containing a material for a silicon carbide fired body and an additive; manufacturing a honeycomb degreased body by carrying out degreasing treatment on the honeycomb molded body; and manufacturing a honeycomb structure including a honeycomb fired body by carrying out firing treatment on the honeycomb degreased body, wherein the material for a silicon carbide fired body is manufactured by a manufacturing method including wet mixing, or wet-pulverizing and wet-mixing at least a silicon carbide powder and an iron compound powder.

According to the method for manufacturing a honeycomb structure of the embodiment of the present invention, a honeycomb structure is manufactured using the material for a silicon carbide fired body manufactured by the predetermined method, that is, a honeycomb structure is manufactured using the material for a silicon carbide fired body containing iron compound powders uniformly distributed therein. Therefore, sintering of the silicon carbide tends to be allowed to proceed certainly, the manufactured honeycomb structure tends to show low pressure loss and smaller variations in a pore diameter and a porosity.

In the present specification, the shape indicated by the word “pillar” refers to any desired shape of a pillar including a round pillar, an oval pillar, a polygonal pillar and the like.

According to the method for manufacturing a honeycomb structure of an embodiment of the present invention, the iron compound powder includes at least one kind selected from a group consisting of Fe₂O₃, Fe₃O₄ and FeO, in the above-mentioned method for manufacturing a honeycomb structure.

In the method for manufacturing a honeycomb structure of the embodiment of the present invention, since the iron compound powder includes at least one kind selected from the group consisting of Fe₂O₃, Fe₃O₄ and FeO, the manufactured honeycomb structure tends to be formed by a honeycomb fired body having been certainly sintered.

According to the method for manufacturing a honeycomb structure of an embodiment of the present invention, the content of the iron compound powder in the material for a silicon carbide fired body is at least about 0.25% by weight and at most about 2.5% by weight, in the above-mentioned method for manufacturing a honeycomb structure.

In the method for manufacturing a honeycomb structure of the embodiment of the present invention, since the content of the above-mentioned iron compound powder is at least about 0.25% by weight and at most about 2.5% by weight, the manufactured honeycomb structure tends to be formed by a honeycomb fired body having been certainly sintered.

In the method for manufacturing a honeycomb structure of an embodiment of the present invention, in a mixture obtained by wet mixing, or wet-pulverizing and wet-mixing the silicon carbide powder and the iron compound powder, an average diameter (D50) of the iron compound powder having been wet mixed, or wet-pulverized and wet-mixed is at least about 0.1 μm and at most about 1.0 μm, and also equal to or less than an average particle diameter (D50) of the silicon carbide powder having been wet mixed, or wet-pulverized and wet-mixed.

As described in the method for manufacturing a honeycomb structure of the embodiment of the present invention, the iron compound powder and the silicon carbide powder tend to be uniformly mixed, by wet mixing or wet-pulverizing and wet-mixing to obtain the iron compound powder having been mixed and the silicon carbide powder having been mixed both of which have average particle diameters within the above-mentioned ranges. Use of a material for a silicon carbide fired body of this kind tends to enable manufacturing of a honeycomb structure formed by a honeycomb fired body on which sintering is proceeded more certainly.

In the method for manufacturing a honeycomb structure of an embodiment of the present invention, the above-mentioned method for manufacturing a honeycomb structure further includes adding and mixing a silicon carbide coarse powder having a larger average particle diameter (D50) than that of the silicon carbide powder having been wet mixed, or wet-pulverized and wet-mixed, to the mixture obtained by wet mixing, or wet-pulverizing and wet-mixing the silicon carbide powder and the iron compound powder.

According to the method for manufacturing a honeycomb structure of the embodiment of the present invention, since the silicon carbide coarse powder having a larger average particle diameter (D50) is additionally added and mixed upon manufacturing a material for a silicon carbide fired body, the obtained material for a silicon carbide fired body contains two kinds of silicon carbide particles each having a different average particle diameter. Use of a material for a silicon carbide fired body of this kind tends to allow sintering of the silicon carbide to proceed certainly, and the manufactured honeycomb structure tends to show smaller variations in a pore diameter and a porosity.

According to the method for manufacturing a honeycomb structure of an embodiment of the present invention, the silicon carbide powder having been wet mixed, or wet-pulverized and wet-mixed has an average particle diameter (D50) of at least about 0.1 μm and at most about 1.0 μm, in the method for manufacturing a honeycomb structure of the above-mentioned embodiment.

Moreover, in the method for manufacturing a honeycomb structure of an embodiment of the present invention, in addition to the methods for manufacturing a honeycomb structure of the above-mentioned embodiments, the silicon carbide coarse powder has an average particle diameter (D50) of at least about 0.3 μm and at most about 50 μm.

According to the methods for manufacturing a honeycomb structure of the embodiments of the present invention, a honeycomb structure suitable for use as a honeycomb filter or a catalyst carrier tends to be suitably manufactured, since a honeycomb structure is manufactured using the above material for a silicon carbide fired.

According to the method for manufacturing a honeycomb structure of an embodiment of the present invention, the content of the iron compound powder in the mixture obtained by wet mixing, or wet-pulverizing and wet-mixing the silicon carbide powder and the iron compound powder is at least about 1% by weight and at most about 10% by weight, in the methods for manufacturing a honeycomb structure of the above-mentioned embodiments.

In the method for manufacturing a honeycomb structure of the embodiment of the present invention, the manufactured honeycomb structure tends to be formed by a honeycomb fired body having been certainly sintered, since the content of iron compound powder is within the above-mentioned range.

In the method for manufacturing a honeycomb structure of an embodiment of the present invention, the methods for manufacturing a honeycomb structure of the above-mentioned embodiments include adding and mixing the silicon carbide coarse powder to the mixture obtained by wet mixing, or wet-pulverizing and wet-mixing, after carrying out drying treatment on the mixture.

According to the method for manufacturing a honeycomb structure of the embodiment of the present invention, since drying treatment is once carried out, upon manufacturing a material for a silicon carbide fired body, on the mixture obtained by wet mixing, or wet-pulverizing and wet-mixing, the silicon carbide powder and/or the iron compound powder have less tendency to agglomerate, resulting in a less amount of powders having a larger size. Use of the material for a silicon carbide fired body tends to allow sintering of the silicon carbide to proceed certainly, and the manufactured honeycomb structure tends to show smaller variations in a pore diameter and a porosity.

According to the method for manufacturing a honeycomb structure of an embodiment of the present invention, a purity of the iron compound powder is more than 80% and equal to or less than about 99%, in the above-mentioned method for manufacturing a honeycomb structure.

In the method for manufacturing a honeycomb structure of the embodiment of the present invention, since the purity of iron compound powder is within the above-mentioned range, the manufactured honeycomb structure tends to be formed by a honeycomb fired body having been certainly sintered.

Hereinafter, the method for manufacturing a material for a silicon carbide fired body of the embodiment of the present invention will be described, and subsequently, the method for manufacturing a honeycomb structure of the embodiment of the present invention will be described.

The method for manufacturing a material for a silicon carbide fired body of the embodiment of the present invention includes wet mixing, or wet-pulverizing and wet-mixing at least a silicon carbide powder and an iron compound powder.

In addition, the method for manufacturing a honeycomb structure of the embodiment of the present invention includes: manufacturing a pillar-shaped honeycomb molded body where a large number of cells are disposed in parallel with one another in a longitudinal direction with a cell wall therebetween by molding a raw material composition containing a material for a silicon carbide fired body and an additive; manufacturing a honeycomb degreased body by carrying out degreasing treatment on the honeycomb molded body; and manufacturing a honeycomb structure including a honeycomb fired body by carrying out firing treatment on the honeycomb degreased body, wherein the material for a silicon carbide fired body is manufactured by a manufacturing method including wet mixing, or wet-pulverizing and wet-mixing at least a silicon carbide powder and an iron compound powder.

First of all, in the above-mentioned method for manufacturing a material for a honeycomb fired body, a silicon carbide powder and an iron compound powder to be used as starting materials are prepared.

As the iron compound powder, a powder including an iron oxide such as Fe₂O₃, Fe₃O₄, and FeO is preferably used. This is because these iron oxides are suitably used for manufacturing a porous silicon carbide sintered body by using a manufactured material for a silicon carbide fired body. The detail will be described later.

Each of these may be used alone, or two or more kinds of these may be used in combination.

Next, the silicon carbide powder and the iron compound powder prepared as starting materials are put into a wet-pulverizing and wet-mixing machine or a wet mixing machine, and then wet mixed.

Wet mixing may be carried out by using the wet mixing machine and starting materials having almost the same particle diameters as those of the silicon carbide powder having been mixed and the iron compound powder having been mixed, or may be carried out by conducting wet-pulverizing and wet-mixing with the use of a wet-pulverizing and wet-mixing machine and starting materials having larger average particle diameters than those of the silicon carbide powder having been mixed and the iron compound powder having been mixed.

In addition, in the mixture (the material for a silicon carbide fired body) obtained by wet mixing, or wet-pulverizing and wet-mixing the silicon carbide powder and the iron compound powder prepared as starting materials, the average particle diameter (D50) of the iron compound powder having been mixed is preferably at least about 0.1 μm and at most about 1.0 μm, and also less than the average particle diameter (D50) of the silicon carbide powder having been mixed.

This is because the iron compound powder and the silicon carbide powder tend to be uniformly mixed in the resulting mixture, by wet mixing, or wet-pulverizing and wet-mixing to obtain the iron compound powder having been mixed and the silicon carbide powder having been mixed both of which have average particle diameters within the above-mentioned ranges.

Preparation of an Iron Compound Powder Mixed to have an Average Particle diameter (D50) of about 0.1 μm or more tends not to require a huge amount of time and costs. In the case where the average particle diameter (D50) of the iron compound powder having been mixed is about 1.0 μm or less, or is equal to or smaller than the average particle diameter (D50) of the silicon carbide powder having been mixed, uniform dispersion of the iron compound powders in the material for a silicon carbide fired body tends not to be difficult.

In the present specification, the average particle diameter (D50) refers to a median diameter based on volume.

Here, a specific measuring method of a particle diameter is briefly described. A particle size (particle diameter) is typically represented as an abundance ratio distribution per particle diameter by integrating the measuring results. This abundance ratio distribution per particle diameter is referred to as a particle size distribution. As a measuring method of the particle size distribution, for example, a laser diffraction scattering method on a principle of a measurement based on a volume, or the like, can be employed. Here, in such a method, the particle size distribution is measured on the assumption that the particles have a spherical shape. Then, the particle size distribution is converted into a cumulative distribution, and therefore the above-mentioned median diameter (the diameter where an amount of particles included in a group having larger particle diameters and an amount of particles included in a group having smaller particle diameters becomes equal when a group of particles is divided into the two groups by a certain particle diameter) is calculated.

The average diameters of the silicon carbide powder having been mixed and the iron compound powder having been mixed can be adjusted by preliminarily adjusting the average particle diameters of the starting materials based on classification and the like. Also, by using the wet-pulverizing and wet-mixing machine, the average diameters of the silicon carbide powder having been mixed and the iron compound powder having been mixed can be adjusted by selecting a suitable processing time.

The wet mixing machine is not particularly limited, and examples thereof include a wet mixing machine such as a tumbler mixer, a jet mixer, a bug mixer, a cone-type mixer, a kneader and a ribbon mixer.

Moreover, the wet-pulverizing and wet-mixing machine is not particularly limited, and examples thereof include a wet-pulverizing and wet-mixing machine such as a colloid mill, a cone mill, a bead mill, a V-type mill, a side mill, a ball mill and an attritor.

In addition, as a solvent to be used upon wet mixing, or wet-pulverizing and wet-mixing, examples thereof include water, alcohol such as methanol and ethanol, propylene glycol, ethylene glycol, benzene, carbon tetrachloride, phenol, acetone, sulfonic acid, oleic acid, butyric acid, naphthenic acid, amyl acetate, a sodium hydroxide solution, a sodium silicate solution, a sodium carbonate solution and the like.

After completion of wet-pulverizing and wet-mixing, or wet mixing, the material for a silicon carbide fired body can be manufactured by carrying out, if necessary, drying treatment on the mixture.

The above-mentioned drying treatment is preferably carried out under a condition in which 100% of the solvent used in the above-mentioned wet mixing, or the wet-pulverizing and wet-mixing can be removed.

The content of the iron compound powder in the material for a silicon carbide fired body is preferably at least about 0.25% by weight and at most about 2.5% by weight. This is because sintering is allowed to proceed excellently upon manufacturing a porous silicon carbide sintered body.

That is, in the case where the content of the iron compound powder is about 0.25% by weight or more, sintering of silicon carbide tends to sufficiently proceed upon manufacturing a porous silicon carbide sintered body using a manufactured material for a silicon carbide fired body. On the other hand, in the case where the content of the above-mentioned iron compound powder is about 2.5% by weight or less, upon manufacturing a porous silicon carbide sintered body using a manufactured material for a silicon carbide fired body, the obtained porous silicon carbide sintered body tends not to have an extremely large pore diameter, and this tends not to lead to insufficient strength.

In addition, a purity of the silicon carbide powder in the material for a silicon carbide fired body is preferably at least about 96.0% and at most about 99.5%.

In the case where the purity of the silicon carbide powder having been mixed is within the above-mentioned range, sintering is allowed to proceed excellently upon manufacturing a porous silicon carbide sintered body. A purity thereof of about 96.0% or more tends not to allow impurities to inhibit proceeding of sintering of the silicon carbide. It tends not to require high costs to set the purity of a silicon carbide powder having been mixed to about 99.5% or less.

Here, in the present specification, the purity of the silicon carbide powder means an amount of the silicon carbide in terms of proportion to compositions other than the iron compound powder contained in the manufactured material for a silicon carbide fired body.

Ideally the material for a silicon carbide fired body contains only the silicon carbide powder and the iron compound powder. However, in practice, unavoidable impurities are contained.

The unavoidable impurities include impurities contained in a starting material, or impurities mixed upon wet-pulverizing and wet-mixing, or wet mixing, and inclusion thereof is unavoidable.

Moreover, in the method for manufacturing a material for a silicon carbide fired body of the embodiment of the present invention, the silicon carbide coarse powder having a larger average particle diameter (D50) than that of the silicon carbide powder having been mixed is preferably additionally mixed to the mixture obtained by wet mixing, or wet-pulverizing and wet-mixing the silicon carbide powder and the iron compound powder prepared as starting materials.

This is because the material for a silicon carbide fired body containing two kinds of silicon carbide particles each having a different average particle diameter tends to allow sintering to certainly proceed, upon manufacturing a porous silicon carbide sintered body, and tends to enable the manufactured porous silicon carbide sintered body to have smaller variations in a pore diameter and a porosity.

Furthermore, in case of employing a manufacturing method including additional mixing of a silicon carbide coarse powder, a silicon carbide powder having been mixed preferably has an average particle diameter (D50) of at least about 0.1 μm and at most about 1.0 μm. A preferable lower limit of the average particle diameter (D50) of the silicon carbide coarse powder is about 0.3 μm, a preferable upper limit thereof is about 50 μm, a more preferable lower limit thereof is about 5 μm, and a more preferable upper limit thereof is about 20 μm.

This is because a manufactured material for a silicon carbide fired body containing the above-mentioned silicon carbide coarse powder is particularly suitably used for manufacturing a porous silicon carbide sintered body having a pore diameter and a porosity suitable for use as a honeycomb filter or a catalyst carrier.

Moreover, in the method for manufacturing a material for a silicon carbide fired body of the embodiment of the present invention, in case of manufacturing a material for a silicon carbide fired body containing the silicon carbide powder and the silicon carbide coarse powder having a larger average particle diameter than that of the silicon carbide powder, that is, in case of manufacturing a material for a silicon carbide fired body containing mixed silicon carbide powders each having a different average particle diameter (D50), the timing for addition of the silicon carbide coarse powder is not particularly limited. Although two kinds of silicon carbide powders each having a different average particle diameter (the silicon carbide powder prepared as a starting material and the silicon carbide coarse powder having a larger average particle diameter than that of the silicon carbide powder) and the iron compound powder prepared as a starting material may be simultaneously mixed at the start, the silicon carbide coarse powder is preferably additionally added and mixed after mixing the silicon carbide powder and the iron compound powder prepared as starting materials.

Furthermore, in case of addition of the silicon carbide coarse powder after mixing the silicon carbide powder and iron compound powder prepared as starting materials, a material for a silicon carbide fired body is preferably manufactured in the following sequence: wet mixing, or wet-pulverizing and wet-mixing is carried out on the silicon carbide powder and the iron compound powder prepared as starting materials to obtain a mixture thereof; drying treatment is carried out on the mixture; and then the silicon carbide coarse powder is mixed to the mixture by dry mixing.

This is because a material for a silicon carbide fired body manufactured by following the above-mentioned sequence allows sintering to excellently proceed. The reason is considered to be as follows.

That is, carrying out the drying treatment once tends to make aggregation of the silicon carbide powder and/or the iron compound powder difficult, and this tends to result in a less amount of powders having a larger size and certain proceeding of sintering.

In addition, the above-mentioned drying treatment tends to allow decrease in variations in a pore diameter and a porosity of a manufactured porous silicon carbide sintered body.

As the silicon carbide powder to be used in the method for manufacturing a material for a silicon carbide fired body of the embodiment of the present invention, although an α-type silicon carbide powder, a β-type silicon carbide powder, or a mixture of the α-type and the β-type silicon carbide powder may be used, the α-type silicon carbide powder is preferably used.

This is because the α-type silicon carbide powder is available at a lower cost and has a superior thermal conductivity, compared with the β-type silicon carbide powder.

In addition, since the α-type silicon carbide powder allows easier control of the pore diameter upon manufacturing a porous silicon carbide sintered body, the α-type silicon carbide powder is suitably used for manufacturing the porous silicon carbide sintered body having a uniform pore diameter.

Next, the method for manufacturing a honeycomb structure of the embodiment of the present invention will be described.

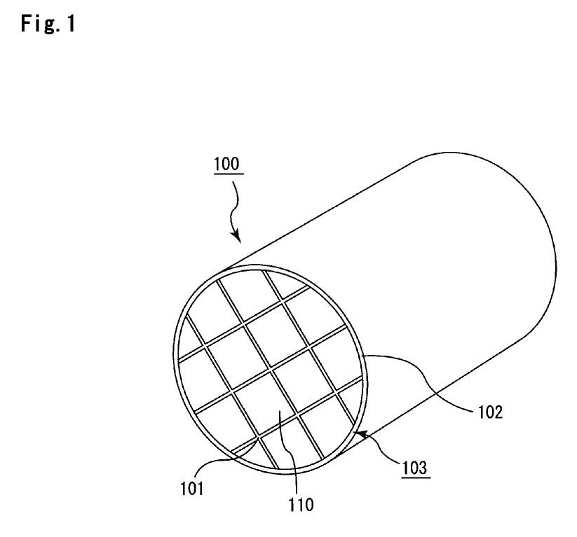

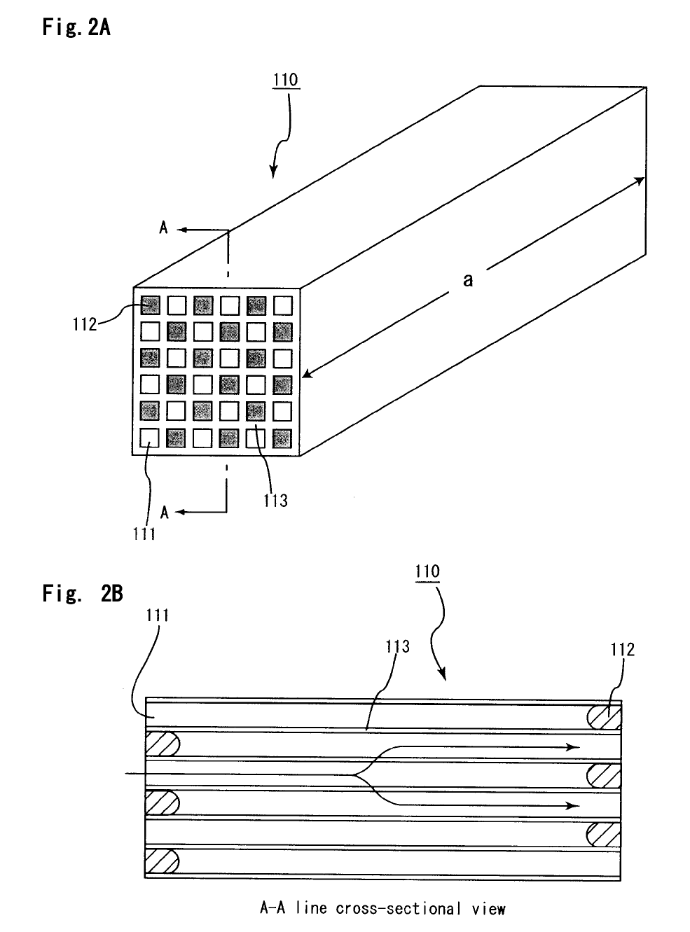

FIG. 1 is a perspective view that schematically shows one example of a honeycomb structure manufactured by the method for manufacturing a honeycomb structure of the embodiment of the present invention. FIG. 2A is a perspective view that schematically shows a honeycomb fired body that constitutes the above-mentioned honeycomb structure, and FIG. 2B is a cross-sectional view taken along line A-A of FIG. 2A.

In a honeycomb structure 100, a plurality of the honeycomb fired bodies 110 shown in FIGS. 2A and 2B are bonded together by interposing a sealing material layer (adhesive layer) 101 to constitute a honeycomb block 103, and a sealing material layer (coat layer) 102 is further formed on the periphery of the honeycomb block 103. Also, as shown in FIG. 2A, in the honeycomb fired body, a large number of cells 111 are disposed in parallel with one another in a longitudinal direction (the direction shown by an arrow a in FIG. 2A), and cell walls 113 individually separating the cells 111 are allowed to function as a filter.

In other words, the end portion of either the exhaust gas-inlet or the exhaust gas-outlet sides of the cell 111 formed in the honeycomb fired body 110 are sealed by a plug 112, as shown in FIG. 2B, so that exhaust gases flowing into one of the cells 111 must pass through the cell wall 113 separating the cells 111 to flow out through another one of the cells 111, and as the exhaust gases pass through the cell wall 113 particulates are captured by the cell wall 113, thereby purifying the exhaust gases.

Hereinafter, the method for manufacturing a honeycomb structure of the embodiment of the present invention will be described in the sequential order of the processing.

In the method for manufacturing a honeycomb structure of the embodiment of the present invention, firstly, a raw material composition including a material for a silicon carbide fired body and an additive is prepared.

As the material for a silicon carbide fired body, a material for a silicon carbide fired body manufactured by the method for manufacturing a silicon carbide fired body of the embodiment of the present invention may be used.

As the additive, examples thereof include an organic binder, a plasticizer, a lubricant and the like.

The binder is not particularly limited, and examples thereof include methyl cellulose, carboxymethyl cellulose, hydroxyethyl cellulose, polyethylene glycol and the like.

Generally, the blending amount of the binder is preferably at least about 1 parts by weight and at most about 10 parts by weight with respect to 100 parts by weight of the material for a silicon carbide fired body.

The plasticizer is not particularly limited, and examples thereof include glycerin and the like.

Also, the lubricant is not particularly limited, and examples thereof include a polyoxyalkylene compound such as polyoxyethylene alkyl ether and polyoxypropylene alkyl ether, and the like.

Specific examples of the lubricant include polyoxyethylene monobutyl ether, polyoxypropylene monobutyl ether and the like.

Furthermore, if necessary, a pore-forming agent such as balloons which are micro hollow spheres including oxide-based ceramics, spherical acrylic particles, graphite and the like, may be added to the raw material composition.

As described above, in the method for manufacturing a honeycomb structure, in case of manufacturing the material for a silicon carbide fired body, the silicon carbide coarse powder having a larger average particle diameter than that of the silicon carbide powder having been mixed is preferably mixed to the mixture obtained by wet mixing, or wet-pulverizing and wet-mixing the silicon carbide powder and the iron compound powder prepared as starting materials. This is because a material for a silicon carbide fired body manufactured by following the above-mentioned sequence allows sintering to excellently proceed.

The reason is considered to be as follows.

The originality of the method for manufacturing a honeycomb structure of the embodiment of the present invention lies in the iron compound powder mixed in the material for a silicon carbide fired body. Here, the purpose for mixing the iron compound powder is explained by removal of carbon contained in the honeycomb molded body manufactured through the post processes upon firing treatment. Specifically, for example, in the case where Fe₂O₃ is contained as the iron oxide powder, the reaction of Fe₂O₃ and carbon as shown in the following equation (1) proceeds, resulting in removal of carbon in the honeycomb molded body.

Fe₂O₃+C⇄2FeO+CO↑ (1)

Here, in order to positively remove the carbon in a honeycomb molded body (honeycomb degreased body), uniform dispersion of the iron compound powders in the material for a silicon carbide fired body is presumably important.

Non-uniform dispersion of the iron compound powders causes a large amount of carbon remained in the honeycomb molded body without proceeding of a reaction with the iron compound powder, possibly resulting in interruption of sintering of the silicon carbide.

In order to uniformly disperse the iron compound powders in the material for a silicon carbide fired body upon manufacturing the material for a silicon carbide fired body, the silicon carbide coarse powder is additionally added and mixed in the mixture obtained by wet mixing, or wet-pulverizing and wet-mixing the silicon carbide powder and the iron compound powder prepared as starting materials.

In the case where the silicon carbide coarse powder having a larger average particle diameter than that of the silicon carbide powder prepared as a starting material is wet mixed at the same time of mixing of the silicon carbide powder and the iron compound powder prepared as a starting material, or the silicon carbide coarse powder is firstly wet mixed with the iron compound powder, and then the silicon carbide powder having a smaller average particle diameter than that of the silicon carbide coarse powder is added and mixed, the iron compound powder tends to be non-uniformly dispersed, leading to difficulties in uniform dispersion of the iron compound powders in the material for a silicon carbide fired body.

Moreover, the raw material composition containing the material for a silicon carbide fired body prepared as described above preferably has a temperature of about 28° C. or less. This is because an excessively high temperature thereof may cause gelatinization of a binder.

Moreover, a proportion of organic compounds in the raw material composition is preferably about 10% by weight or less, and a content of moisture is preferably at least about 8% by weight and at most about 20% by weight.

Next, the raw material composition is extrusion-molded by an extrusion-molding method and the like. Subsequently, the molded body obtained by extrusion-molding is cut by a cutting machine to manufacture a honeycomb molded body having no sealing and the same shape as the pillar-shaped honeycomb fired body 110 shown in FIG. 2A.

Next, if necessary, either one end of each cell of the honeycomb molded body is filled with a predetermined amount of a plug material paste, which will serve as the plug, so as to seal the cells.

Specifically, upon manufacturing a honeycomb structure that functions as a ceramic filter, either end of each cell is sealed.

Here, drying treatment may be carried out, if necessary, before sealing the honeycomb molded body. In this case, the drying treatment is carried out by using a microwave drying apparatus, a hot air drying apparatus, a reduced pressure drying apparatus, a dielectric drying apparatus, a freeze drying apparatus and the like.

Although the above-mentioned plug material paste is not particularly limited, a paste to form, through the post-processes, a plug having a porosity of at least about 30% and at most about 75% is preferably used, and for example, a paste having the same composition as the above-mentioned raw material composition may be used.

Filling with the above-mentioned plug material paste may be carried out, if necessary, and in the case of being filled with the above-mentioned plug material paste, for example, the honeycomb structure manufactured through the post processes can be suitably used as a ceramic filter, and in the case of not being filled with the above-mentioned plug material paste, for example, the honeycomb structure manufactured through the post processes can be suitably used as a catalyst supporting carrier.

Next, degreasing treatment is carried out under predetermined conditions (for example, at a temperature of at least about 200° C. and at most about 500° C. for at least about 2 hours and at most about 4 hours) on the honeycomb molded body with the plug material paste charged therein according to necessity.

Next, by carrying out firing treatment under predetermined conditions (for example, at a temperature of at least about 1400° C. and at most about 2300° C.) on the degreased honeycomb molded body (honeycomb degreased body), a pillar-shaped honeycomb fired body where a plurality of the cells are disposed in parallel with one another in a longitudinal direction with the cell wall therebetween, and either one end of each of the above-mentioned cells is sealed, is manufactured.

Here, as conditions for degreasing or firing the above-mentioned honeycomb molded body, conventional conditions having been used for manufacturing a filter including porous ceramics can be used.

In the method for manufacturing a honeycomb structure of the embodiment of the present invention, as described above, since a powder including iron oxide such as Fe₂O₃, Fe₃O₄ and FeO as the iron compound powder is contained in the material for a silicon carbide fired body, a reaction shown in the above-mentioned reaction formula (1) or a reaction shown in a reaction formula (2) or (3) progresses rightward to remove carbon contained in the honeycomb degreased body.

Fe₃O₄+C⇄3FeO+CO↑ (2)

FeO+C⇄Fe+CO| (3)

As described above, removal of the carbon in the honeycomb degreased body allows easy contact between the silicon carbide powders, and this tends to result in certain proceeding of sintering of the silicon carbide.

The reason why the powder containing iron oxide such as Fe₂O₃, Fe₃O₄, and FeO is preferably used as the above-mentioned iron compound powder is that the above-mentioned iron oxide is a low-price material, and even when the iron oxide is remained in a porous silicon carbide sintered body, the iron oxide will tend not to corrode the silicon carbide sintered body.

Next, a sealing material paste is applied with an even thickness to a side face of the honeycomb fired body to form a sealing material layer (adhesive layer), and by repeating successively laminating another honeycomb fired body on this adhesive paste layer, an aggregated body of honeycomb fired bodies having a predetermined size is manufactured.

Examples of the sealing material paste include a material including a combination of an inorganic binder, an organic binder, and inorganic fibers and/or inorganic particles, and the like.

Examples of the inorganic binder include silica sol, alumina sol and the like. These may be used alone, or two or more kinds of these may be used in combination. Out of the above-mentioned inorganic binders, silica sol is preferably used.

Examples of the organic binder include polyvinyl alcohol, methyl cellulose, ethyl cellulose, carboxymethyl cellulose and the like. These may be used alone, or two or more kinds of these may be used in combination. Out of the above-mentioned organic binders, carboxymethyl cellulose is preferably used.

Examples of the inorganic fiber include ceramic fibers made from silica-alumina, mullite, alumina, silica, and the like. These may be used alone, or two or more kinds of these may be used in combination. Out of the above-mentioned inorganic fibers, an alumina fiber is preferably used.

Examples of the inorganic particles include carbide, nitride and the like. Specific examples thereof include an inorganic powder such as silicon carbide, silicon nitride and boron nitride, and the like. These may be used alone, or two or more kinds of these may be used in combination. Out of the above-mentioned inorganic particles, silicon carbide is preferably used, due to the excellent thermal conductivity.

Furthermore, if necessary, a pore-forming agent such as balloons which are micro hollow spheres including oxide-based ceramics, spherical acrylic particles, graphite and the like, may be added to the above-mentioned sealing material paste.

The above-mentioned balloons are not particularly limited, and examples thereof include alumina balloons, glass micro balloons, shirasu balloons, fly ash balloons (FA balloons), mullite balloons and the like. Out of these, alumina balloons are preferably used.

Next, the aggregated body of honeycomb fired bodies is heated so that the sealing material paste is dried and solidified to form the sealing material layer (adhesive layer).

Next, by using a diamond cutter and the like, cutting is carried out on the aggregated body of honeycomb fired bodies, where a plurality of the honeycomb fired bodies are bonded together by interposing the sealing material layer (adhesive layer), thereby manufacturing a round pillar-shaped honeycomb block.

Afterward, the sealing material layer (coat layer) is formed on the periphery of the honeycomb block by using the above-mentioned sealing material paste, thereby manufacturing a honeycomb structure having the sealing material layer (coat layer) formed on the periphery of the round pillar-shaped honeycomb block where a plurality of the honeycomb fired bodies are bonded together by interposing the sealing material layer (adhesive layer).

Afterward, if necessary, a catalyst is supported on the honeycomb structure. The catalyst may be supported on the honeycomb fired body before manufacturing the aggregate body.

Upon supporting the catalyst thereon, desirably, an alumina film (layer) having a high specific surface area is formed on the surface of the honeycomb structure, and a co-catalyst and a catalyst such as platinum are applied to the surface of this alumina film (layer).

Examples of methods for forming the alumina film on the surface of the above-mentioned honeycomb structure include a method in which the honeycomb structure is impregnated with a solution of a metal compound containing aluminum such as Al(NO₃)₃ and then heated, a method in which the honeycomb structure is impregnated with a solution containing an alumina powder and then heated, and the like.

Examples of a method for applying the co-catalyst to the alumina film include a method in which the honeycomb structure is impregnated with a solution of a metal compound containing a rare-earth element such as Ce(NO₃)₃, and the like and then heated.

Example of a method for applying the catalyst on the alumina film include a method in which the honeycomb structure is impregnated with a nitric acid solution of dinitro diamine platinum ([Pt(NH₃)₂(NO₂)₂]HNO₃: about 4.53% by weight in platinum concentration) or the like and then heated, and the like.

Moreover, the catalyst may be applied in such a manner that a catalyst is preliminarily applied to alumina particles and the honeycomb structure is impregnated with a solution containing the alumina powder to which the catalyst has been applied, and then heated.

Also, although the method for manufacturing a honeycomb structure of the embodiment of the present invention described hereinabove is a method for manufacturing an aggregated honeycomb structure, the honeycomb structure to be manufactured by the manufacturing method of the embodiment of the present invention may be a honeycomb structure where the pillar-shaped honeycomb block is formed by a single honeycomb fired body (integral honeycomb structure).

For manufacturing an integral honeycomb structure of this kind, first, a honeycomb molded body is manufactured by using the same method as that used for manufacturing the aggregated honeycomb structure, except that the honeycomb molded body to be formed through extrusion-molding has a larger size and a different outer shape in comparison with those of the aggregated honeycomb structure.

Next, if necessary, drying treatment and/or charging of a plug material paste are/is carried out in the same manner as in the manufacturing of the aggregated honeycomb structure, and after that, degreasing and firing are carried out in the same manner as in the manufacturing of the aggregated honeycomb structure, thereby manufacturing a honeycomb block, and then, an integral honeycomb structure is manufactured by forming a sealing material layer (coat layer) if necessary. Here, a catalyst may be supported on the integral honeycomb structure by the method described above.

In the above-mentioned method for manufacturing a honeycomb structure of the embodiment of the present invention, a honeycomb structure having a predetermined shape can be favorably manufactured.

Although the description in the above has mainly discussed as a honeycomb structure a honeycomb filter used for capturing particulates in exhaust gases, the honeycomb structure can be suitably used as a catalyst supporting carrier (honeycomb catalyst) for converting exhaust gases as well.

Namely, a honeycomb structure with cells each having either one of ends being sealed is suitably used as a honeycomb filter, and a honeycomb structure having cells without sealed ends is suitably used as a catalyst carrier.

### EXAMPLES

The following will describe the present invention in more detail by means of examples; however, the present invention is not limited to only these examples.

### Example 1

(1) An amount of 96 kg of an α-type silicon carbide powder having an average particle diameter (D50) of 12 μm and 4 kg of a Fe₂O₃ powder (manufactured by Wako Pure Chemical Industries, Ltd., purity: 95% or more) having an average particle diameter (D50) of 1.0 μm were prepared as starting materials and wet-pulverized and wet-mixed using a wet-pulverizing and wet-mixing machine to obtain a mixture containing an α-type silicon carbide powder (also referred to as an silicon carbide fine powder) having an average particle diameter (D50) of 0.5 μm and a Fe₂O₃ powder having an average particle diameter (D50) of 0.5 μm. Here, a NaOH solution was used as a solvent for wet-pulverizing and wet-mixing.

In all Examples, Reference Example and Comparative Example including the present Example, average particle diameters were measured by a laser diffraction scattering method.

The content of the Fe₂O₃ powder in the above-mentioned mixture was 4% by weight.

(2) Next, after drying the mixture with a drying apparatus, 300 kg of an α-type silicon carbide coarse powder having an average particle diameter (D50) of 12 μm was added to the dried mixture, and dry mixed using a dry mixing machine to manufacture a material for a silicon carbide fired body.

The content of the Fe₂O₃ powder in the material for a silicon carbide fired body was 1% by weight.

### Example 2

A material for a silicon carbide fired body was manufactured in the same manner as that of Example 1, except that, in the process (1) of Example 1, a Fe₃O₄ powder (manufactured by Wako Pure Chemical Industries, Ltd., purity: 95% or more) prepared to have an average particle diameter (D50) of 1.0 μm was used in place of the Fe₂O₃ powder.

### Example 3

A material for a silicon carbide fired body was manufactured in the same manner as that of Example 1, except that, in the process (1) of Example 1, a FeO powder (manufactured by Wako Pure Chemical Industries, Ltd., purity: 95% or more) prepared to have an average particle diameter (D50) of 1.0 μm was used in place of the Fe₂O₃ powder.

### Examples 4, 5

A material for a silicon carbide fired body was manufactured in the same manner as that of Example 1, except that, in the process (1) of Example 1, the compounding amount of the Fe₂O₃ powder was changed to 1 kg (Example 4) and 10 kg (Example 5).

Here, the contents of the Fe₂O₃ powder in the materials for a silicon carbide fired body were 0.25% by weight and 2.46% by weight in Example 4 and Example 5, respectively.

### Example 6

A material for a silicon carbide fired body was manufactured in the same manner as that of Example 1, except that, in the process (1) of Example 1, 96 kg of an α-type silicon carbide powder having an average particle diameter (D50) of 12 μm and 4 kg of a Fe₂O₃ powder (manufactured by Wako Pure Chemical Industries, Ltd., purity: 95% or more) having an average particle diameter (D50) of 1.0 μm were prepared as starting materials and wet-pulverized and wet-mixed using a wet-pulverizing and wet-mixing machine to obtain a mixture containing an α-type silicon carbide powder (also referred to as an silicon carbide fine powder) having an average particle diameter (D50) of 0.1 μm and a Fe₂O₃ powder having an average particle diameter (D50) of 0.1 μm.

### Example 7

A material for a silicon carbide fired body was manufactured in the same manner as that of Example 1, except that, in the process (1) of Example 1, 96 kg of an α-type silicon carbide powder having an average particle diameter (D50) of 12 μm and 4 kg of Fe₂O₃ powder (manufactured by Wako Pure Chemical Industries, Ltd., purity: 95% or more) having an average particle diameter (D50) of 1.0 μm were prepared as starting materials and wet-pulverized and wet-mixed using a wet-pulverizing and wet-mixing machine to obtain a mixture containing an α-type silicon carbide powder having an average particle diameter (D50) of 1.0 μm and a Fe₂O₃ powder having an average particle diameter (D50) of 1.0 μm.

### Example 8

A material for a silicon carbide fired body was manufactured in the same manner as that of Example 1, except that, in the process (2) of Example 1, an α-type silicon carbide coarse powder having an average particle diameter (D50) of 5 μm was used, in place of the α-type silicon carbide coarse powder having an average particle diameter (D50) of 12 μm.

### Example 9

A material for a silicon carbide fired body was manufactured in the same manner as that of Example 1, except that, in the process (2) of Example 1, an α-type silicon carbide coarse powder having an average particle diameter (D50) of 20 μm was used, in place of the α-type silicon carbide coarse powder having an average particle diameter (D50) of 12 μm.

### Reference Example

A material for a silicon carbide fired body was manufactured in the same manner as that of Example 1, except that, in the process (2) of Example 1, an α-type silicon carbide coarse powder having an average particle diameter (D50) of 0.5 μm was used, in place of the α-type silicon carbide coarse powder having an average particle diameter (D50) of 12 μm. Accordingly, both of the α-type silicon carbide powder contained in the mixture manufactured in the process (1) and the α-type silicon carbide powder added in the process (2) had an average particle diameter (D50) of 0.5 μm.

### Comparative Example

A material for a silicon carbide fired body was manufactured in the same manner as that of Example 1, except that a Fe₂O₃ powder was not mixed in the process (1) of Example 1.

Next, honeycomb structures were manufactured by carrying out the following processes (i) to (vii) using the materials for a silicon carbide fired body manufactured in Examples 1 to 9, Reference Example, and Comparative Example.

(i) An amount of 350 kg of the above-mentioned material for a silicon carbide fired body and 20 kg of an organic binder (methyl cellulose) were mixed to prepare a mixed powder.

Next, separately, 12 kg of a lubricant (manufactured by NOF CORPORATION, UNILUB), 5 kg of a plasticizer (glycerin) and 65 kg of water were mixed to prepare a liquid mixture, and the liquid mixture and the mixed powder were mixed using a wet mixing machine to prepare a wet mixture.

(ii) Next, using a conveyer, the wet mixture was conveyed to an extrusion-molding machine, and then charged into a material charging port.

Subsequently, by carrying out extrusion-molding, a molded body having the same shape as the one shown in FIG. 2A, except that end portions of cells are not sealed, was manufactured.

(iii) Next, the honeycomb molded body was dried by using a drying apparatus that applies microwave and hot-air in combination, and subsequently, predetermined cells were filled with a plug material paste having the same composition as the wet mixture.

Furthermore, after again drying by using the drying apparatus, degreasing was carried out on the honeycomb molded body filled with the plug material paste under the conditions: a degreasing temperature of 350° C.; an O₂ concentration in the atmosphere of 9%; and degreasing time of 3 hours, thereby manufacturing a honeycomb degreased body.

(iv) Next, by carrying out firing at a temperature of 2200° C. in a normal-pressure argon atmosphere for 3 hours, a rectangular pillar-shaped honeycomb fired body including a silicon carbide sintering body having a porosity of 40%, a size of 34.3 mm×34.3 mm×150 mm, the number of cells (cell density) of 46.5 pcs/cm2, and a cell wall thickness of 0.25 mm, was manufactured.

(v) Next, a round pillar-shaped honeycomb block having a sealing material layer (adhesive layer) with a thickness of 1.0 mm was manufactured by adhering a large number of honeycomb fired bodies together by using a heat resistant sealing material paste (adhesive layer paste) containing 30% by weight of an alumina fiber having an average fiber length of 20 μm, 21% by weight of a silicon carbide particle having an average particle diameter of 0.6 μm, 15% by weight of silica sol, 5.6% by weight of carboxymethyl cellulose, and 28.4% by weight of water; drying at a temperature of 120° C.; and then cutting by using a diamond cutter.

(vi) Next, a sealing material paste (coat layer paste) was prepared by mixing and kneading together 23.3% by weight of a silica-alumina fiber (average fiber length of 100 μm, average fiber diameter of 10 μm) as an inorganic fiber, 30.2% by weight of a silicon carbide powder having an average particle diameter of 0.3 μm as an inorganic particle, 7% by weight of silica sol (SiO₂ content within the sol: 30% by weight) as an inorganic binder, 0.5% by weight of carboxymethyl cellulose as an organic binder and 39% by weight of water.

(vii) Next, by using the sealing material paste (coat layer paste), a sealing material paste layer having a thickness of 0.2 mm was formed on the periphery of the honeycomb block. This sealing material paste was then dried at a temperature of 120° C. to manufacture a round pillar-shaped honeycomb structure having a size of 143.8 mm×150 mm in diameter and length with the sealing material layer (coat layer) formed on the periphery thereof.

As results of manufacturing the honeycomb structures using the materials for a silicon carbide fired body manufactured in Examples 1 to 9, Reference Example and Comparative Example, use of the materials for a silicon carbide fired body manufactured in Examples 1 to 9 enabled manufacturing honeycomb structures having a desired pore diameter (8 to 12 μm) (set value) causing low pressure loss.

The honeycomb structure manufactured using the material for a silicon carbide fired body manufactured in Reference Example has a pore diameter in a wider range (5 to 15 μm) than that of the desired pore diameter, and showed inferior properties in terms of variation in the pore diameters and pressure loss, in comparison with the honeycomb structures manufactured using the materials for a silicon carbide fired body manufactured in Examples. The reason is considered to be as follows: the average particle diameter (D50) of the α-type silicon carbide powder added in the process (2) of Reference Example was as small as 0.5 μm, and the same as the average particle diameter of the α-type silicon carbide powder contained in the mixture manufactured in the process (1) (the material for a silicon carbide sintered body of Reference Example contained no α-type silicon carbide coarse powder.)

On the other hand, in case of using the material for a silicon carbide fired body manufactured in Comparative Example, the manufactured honeycomb structure failed to have a sufficiently large pore diameter (3 to 9 μm) and had a larger variation in the pore diameters, and also had a lower strength than those obtained by using the materials for a silicon carbide fired body manufactured in Examples 1 to 9 and Reference Example.

Here, the pore diameter was measured using a fine-pore distribution measuring apparatus (Autopore III 9405, manufactured by Shimadzu Corp.) by mercury porosimetry, and initial pressure loss under a flow rate of 1000 N·m3/h was measured as the pressure loss.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A method for manufacturing a material for a silicon carbide fired body, the method comprising:
wet mixing at least a silicon carbide powder and an iron compound powder.

2. The method for manufacturing a material for a silicon carbide fired body according to claim 1, wherein said iron compound powder comprises at least one of Fe₂O₃, Fe₃O₄ and FeO.

3. The method for manufacturing a material for a silicon carbide fired body according to claim 1, wherein the content of said iron compound powder in said material for a silicon carbide fired body is at least about 0.25% by weight and at most about 2.5% by weight.

4. The method for manufacturing a material for a silicon carbide fired body according to claim 1, wherein, in a mixture obtained by wet mixing said silicon carbide powder and said iron compound powder, an average diameter (D50) of said iron compound powder having been wet mixed is at least about 0.1 μm and at most about 1.0 μm and equal to or less than an average particle diameter (D50) of said silicon carbide powder having been wet mixed.

5. The method for manufacturing a material for a silicon carbide fired body according to claim 1, the method further comprising:
adding and mixing a silicon carbide coarse powder having a larger average particle diameter (D50) than an average particle diameter of said silicon carbide powder having been wet mixed to the mixture obtained by wet mixing said silicon carbide powder and said iron compound powder.

6. The method for manufacturing a material for a silicon carbide fired body according to claim 5, wherein said silicon carbide powder having been wet mixed has an average particle diameter (D50) of at least about 0.1 μm and at most about 1.0 μm.

7. The method for manufacturing a material for a silicon carbide fired body according to claim 5, wherein said silicon carbide coarse powder has an average particle diameter (D50) of at least about 0.3 μm and at most about 50 μm.

8. The method for manufacturing a material for a silicon carbide fired body according to claim 5, wherein the content of said iron compound powder in the mixture obtained by wet mixing said silicon carbide powder and said iron compound powder is at least about 1% by weight and at most about 10% by weight.

9. The method for manufacturing a material for a silicon carbide fired body according to claim 5, the method comprising:
adding and mixing the silicon carbide coarse powder with a dried mixture obtained by drying the mixture.

10. The method for manufacturing a material for a silicon carbide fired body according to claim 1, wherein a purity of said iron compound powder is more than about 80% and equal to or less than about 99%.

11. The method for manufacturing a material for a silicon carbide fired body according to claim 1, wherein a wet mixing machine to be used upon the wet mixing includes a tumbler mixer, a jet mixer, a bug mixer, a cone-type mixer, a kneader, or a ribbon mixer.

12. The method for manufacturing a material for a silicon carbide fired body according to claim 1, wherein wet-mixing comprises wet-pulverizing at least the silicon carbide powder and the iron compound powder.

13. The method for manufacturing a material for a silicon carbide fired body according to claim 1, wherein at least one of water, alcohol, propylene glycol, ethylene glycol, benzene, carbon tetrachloride, phenol, acetone, sulfonic acid, oleic acid, butyric acid, naphthenic acid, amyl acetate, a sodium hydroxide solution, a sodium silicate solution, and a sodium carbonate solution is used as a solvent for wet mixing.

14. The method for manufacturing a material for a silicon carbide fired body according to claim 5, wherein a purity of the silicon carbide powder or the silicon carbide coarse powder is at least about 96.0% and at most about 99.5% as an amount of the silicon carbide in terms of proportion to compositions other than the iron compound powder contained in the material for a silicon carbide fired body.

15. The method for manufacturing a material for a silicon carbide fired body according to claim 1, wherein the silicon carbide powder is an α-type silicon carbide powder.

16. A method for manufacturing a honeycomb structure, the method comprising:
wet mixing at least a silicon carbide powder and an iron compound powder to manufacture a material for a silicon carbide fired body;
molding a raw material composition containing the material for a silicon carbide fired body and an additive to manufacture a pillar-shaped honeycomb molded body which has cell walls extending along a longitudinal direction of the honeycomb molded body to define a plurality of cells extending along the longitudinal direction;
degreasing said honeycomb molded body to manufacture a honeycomb degreased body; and
firing said honeycomb degreased body to manufacture a honeycomb structure including a honeycomb fired body.

17. The method for manufacturing a honeycomb structure according to claim 16, wherein said iron compound powder comprises at least one of Fe₂O₃, Fe₃O₄ and FeO.

18. The method for manufacturing a honeycomb structure according to claim 16, wherein the content of said iron compound powder in said material for a silicon carbide fired body is at least about 0.25% by weight and at most about 2.5% by weight.

19. The method for manufacturing a honeycomb structure according to claim 16, wherein, in a mixture obtained by wet mixing said silicon carbide powder and said iron compound powder, an average diameter (D50) of said iron compound powder having been wet mixed is at least about 0.1 μm and at most about 1.0 μm and equal to or less than an average particle diameter (D50) of said silicon carbide powder having been wet mixed.

20. The method for manufacturing a honeycomb structure according to claim 16, the method further comprising:
adding a silicon carbide coarse powder having a larger average particle diameter (D50) than an average particle diameter of said silicon carbide powder having been wet mixed to the mixture obtained by wet mixing said silicon carbide powder and said iron compound powder.

21. The method for manufacturing a honeycomb structure according to claim 20, wherein said silicon carbide powder having been wet mixed has an average particle diameter (D50) of at least about 0.1 μm and at most about 1.0 μm.

22. The method for manufacturing a honeycomb structure according to claim 20, wherein said silicon carbide coarse powder has an average particle diameter (D50) of at least about 0.3 μm and at most about 50 μm.

23. The method for manufacturing a honeycomb structure according to claim 20, wherein the content of said iron compound powder in the mixture obtained by wet mixing said silicon carbide powder and said iron compound powder is at least about 1% by weight and at most about 10% by weight.

24. The method for manufacturing a honeycomb structure according to claim 20, the method further comprising:
mixing the silicon carbide coarse powder with dried mixture obtained by drying the mixture.

25. The method for manufacturing a honeycomb structure according to claim 16, wherein a purity of said iron compound powder is more than about 80% and equal to or less than about 99%.

26. The method for manufacturing a honeycomb structure according to claim 16, wherein a wet mixing machine to be used upon the wet mixing includes a tumbler mixer, a jet mixer, a bug mixer, a cone-type mixer, a kneader, or a ribbon mixer.

27. The method for manufacturing a honeycomb structure according to claim 16, wherein wet-mixing comprises wet-pulverizing at least the silicon carbide powder and the iron compound powder.

28. The method for manufacturing a honeycomb structure according to claim 16, wherein at least one of water, alcohol, propylene glycol, ethylene glycol, benzene, carbon tetrachloride, phenol, acetone, sulfonic acid, oleic acid, butyric acid, naphthenic acid, amyl acetate, a sodium hydroxide solution, a sodium silicate solution, and a sodium carbonate solution is used as a solvent for wet mixing.

29. The method for manufacturing a honeycomb structure according to claim 20, wherein a purity of the silicon carbide powder or the silicon carbide coarse powder is at least about 96.0% and at most about 99.5% as an amount of the silicon carbide in terms of proportion to compositions other than the iron compound powder contained in the material for a silicon carbide fired body.

30. The method for manufacturing a honeycomb structure according to claim 16, wherein the silicon carbide powder is an α-type silicon carbide powder.

31. The method for manufacturing a honeycomb structure according to claim 16, the method further comprising:
sealing either one end of each of the plurality of cells.

32. The method for manufacturing a honeycomb structure according to claim 16, the method further comprising:
supporting a catalyst.

33. The method for manufacturing a material for a silicon carbide fired body according to claim 12, wherein at least one of a colloid mill, a cone mill, a bead mill, a V-type mill, a side mill, a ball mill, and an attritor is used for wet-pulverizing and wet-mixing.

34. The method for manufacturing a honeycomb structure according to claim 27, wherein at least one of a colloid mill, a cone mill, a bead mill, a V-type mill, a side mill, a ball mill, and an attritor is used for wet-pulverizing and wet-mixing.
